(19) United States
(12) Patent Application Publication
(10) Pub. No.: US 2002/0050066 A1
(43) Pub. Date: May 2, 2002

(54) Cutting blade

(76) Inventor: Dieter Krauss, Markt Rettenbach (DE)

Correspondence Address: JACOBSON, PRICE, HOLMAN & STERN, PROFESSIONAL LIMITED LIABILITY COMPANY, 400 Seventh Street, N.W., Washington, DC, 20004, US

(21) Appl. No.: 09/961,260

(22) Filed: Sep. 25, 2001

(30) Foreign Application Priority Data
Sep. 25, 2000 (DE) 200 16 532.1

(51) Int. Cl. B27B 9/02

(52) U.S. Cl. 30/376; 83/810

(57) ABSTRACT

The invention relates to a cutting blade, in particular a cutting blade for a cutting machine which slices food, the cutting blade being rotatably mounted about a fulcrum and the cutting edge arranged at the edge of the cutting blade being spiral in design and the cutting edge following the following functional correlation formulated in polar coordinates, at least in portions: r=f (α). Here r describes the distance of the cutting edge from the fulcrum, α describes the angular distance with respect to the zero line, in other words an angle, and f describes any mathematical non-linear function.

### BACKGROUND OF THE INVENTION

The invention relates to a cutting blade, in particular a cutting blade for a cutting machine which slices food, the cutting blade being rotatably mounted about a fulcrum and the cutting edge arranged at the edge of the cutting blade being spiral in design and the cutting edge following the following functional correlation formulated in polar coordinates, at least in portions: r=f (α). Here r describes the distance of the cutting edge from the fulcrum, α describes the angular distance with respect to the zero line, in other words an angle, and f describes any mathematical function.

Cutting blades of the above-mentioned type are used in cutting machines which are provided for slicing lengths of food such as sausage or slabs of cheese. Industrially produced sausages or lengths of food (with considerable weight and considerable length), for example, are sliced on an industrial scale in cutting machines of this type. Known machines reach between 600 and 1,000 cuts per minute.

Two concepts are known for separating the product slice from the product slab. In the first, the disc-like cutting blade is placed on a planet-like rotor which rotates periodically and regularly releases the product slab for a forward feed. As the construction of the blade drive is relatively complex, the use of spiral cutting blades is also known. The advantage of spiral cutting blades is that, in an appropriate design of the cutting blade, the cutting blade does not have to be moved away from the product for the product to be conveyed forward. For this purpose, owing to the spiral shape, a corresponding shoulder is provided on the cutting blade which is used to move the product forward accordingly at the right moment. It is clear that by using the spiral blade, the complex planet-like drive can be dispensed with.

In known spiral blades, the cutting edge is guided in accordance with an Archimedean spiral. There is a linear correlation, between the distance r of the cutting edge from the fulcrum and the angular distance α (the angle), expressed in polar coordinates, as follows:

r=k*α.

However, the use of spiral blades following an Archimedean spiral is not ideal in high power cutting machines. In high power cutting machines, the aim is to produce at least 1,000 cuts per minute.

When separating the product slice from the product slab two different force components arranged at right angles (or orthogonally) to one another need to be considered. With the drawing cut, the cutting blade moves parallel to the product surface, or the force component is described therewith which is tangential on the cutting blade

Arranged at right angles thereto is the force component of the pressing cut, which force component acts radially with respect to the circular blade and at right angles to the surface with respect to the product.

The result is that when using the known cutting blades in high power cutting machines, the speed of rotation of the spiral blade has to be increased accordingly. This leads to the force component of the pressing cut being so great that no clean cut can be achieved, rather the slice is virtually chopped off the slab.

The above-mentioned cutting machines are described, for example, in German Offenlegungsschrift 195 14 407, German Patent specification 38 33 596 and in German Utility Model 91 16 036.

German Utility Model 91 16 036 describes a cutting blade designed as an Archimedean spiral which, in the back region in the direction of rotation, is also equipped with cutting teeth. A design of this type of the cutting blade is relatively complex and it should also be noted that the cutting faces of the individual teeth act on the product to be cut at various cutting angles and therefore inevitably produce force components in certain conditions which lead to an unclean cut.

German offenlegungsschrift 195 14 407 and German Patent specification 38 33 596 divide a spiral cutting blade into a plurality of sectors with an Archimedean spiral, the respective design of which is different in the various sectors. The cutting result is to be improved hereby, even if, with a discontinuous transition between the sectors (German offenlegungsschrift 195 14 407), there are also likely to be impairments in the cutting result. German patent specification 38 33 596 greatly increases, in the middle sector, the increase in radii compared to the two outer regions, which leads to a corresponding adjustment in the relative cutting angle and also increases the cutting speed and the pressing force when the speed of rotation of the cutting blade is constant and can thus lead, for example, to torn out slices or faulty cuts in the product to be cut.

In the known disc-like circular blades, in addition to the speed of rotation of the rotor which determines the cutting action, there was also the possibility of increasing the speed of rotation of the circular blade itself and therefore to increase correspondingly the force components of the drawing step and therefore to achieve cleanly separated slices even in the case of high speeds of rotation or high outputs of the machine.

### BRIEF SUMMARY OF THE INVENTION

It is an object of the present invention to improve a cutting blade as described at the outset such that this leads to usable cuts even when used at high speeds.

To achieve this object it is proposed that instead of the known linear correlation between the angle a and the distance r of the cutting edge from the fulcrum, a non-linear function is selected. It is therefore proposed to design the mathematical function which exists between distance r and the angle α in such a way that the degree of the polynomial describing the function does not equal 1. It is therefore possible, for example, to select a quadratic or higher functional correlation. However, it is also possible to select a correlation, the polynomial degree of which is less than 1, for example r≈α. When deviating from the classic Archimedean spiral shape it has been found that, as a result, the setting angle of the cutting blade when immersed in the product is changed in such a way that the component of the drawing cut compared to the component of the pressing cut is increased and therefore a clean cut takes place even at high cutting speeds.

### DETAILED DESCRIPTION

In the preferred embodiment of the invention it is provided that the cutting edge is arranged inside an Archimedean spiral contour, wherein the following mathematical correlation applies:

r=f (α)<k*α+a for α>0.

The gradient factor is to be k here and a the radius at α=0°.

In a cutting blade following a known Archimedean spiral, a constant gradient is provided via the angle. This leads to a different gradient angle at the periphery and also to a relatively large gradient angle at the start of the spiral and therefore to relatively large force components of the pressing cut. This means that the chopping effect at the very beginning of the blade is relatively high, wherein, in particular when the blade is immersed in the product at the beginning, no notch effect of the already separated sliced part can be exploited in the product to facilitate slicing off of the product. Due to the advantageous development of the invention in such a way that the cutting edge follows inside an Archimedean spiral, (given the same starting radius), the proportion of the pressing cut at the beginning is significantly reduced, so the chopping effect is reduced in principle and a clean insertion of the blade into the product to be sliced is also achieved in particular, at the beginning.

It is proposed according to the invention that the functional correlation r=f (α) consists in an interval of a with the lower limits of 0° to 100° and the upper limit of 245° to 345°. It is proposed that the cutting blade according to the invention is not only operated on a statically orientated drive shaft, but is also used in a rotating manner on a rotor. In a manner similar to that in known circular blade discs, the rotary movement is exploited to advance the product again at the moment of release of the product. Depending on how the cutting blade is used, a smaller or larger interval is provided for the functional correlation, as described. In the preferred embodiment it is provided that the functional correlation starts at 0°.

The upper limit can be between 245° and 345°. However, it is also known to begin the functional correlation after a specific angle at which a different correlation is selected (for example with a constant radius). The upper limit for this interval is preferably assumed to be 300°, a range of 60° being produced in which the product is released to be conveyed.

In a preferred embodiment of the invention it is provided that the functional correlation r=f (α) is selected in such a way that the force fraction of drawing and pressing cut is in a constant ratio over the active cutting edge length. This ratio exists in particular when the blade is immersed in the product to be cut, the ratio being selected in such a way that no chopping effect occurs. It is provided in a preferred embodiment that the drawing and pressing force fraction of the cut is equally large and the ratio is therefore 1.

Owing to the constancy of the force ratio along the active cutting edge length the product slice is always separated with parameters which always remain the same and attention does not need to be paid to any changing edge conditions during the cut.

In a preferred embodiment of the invention, it has been found that it is favourable if the functional correlation r=f (α) is selected in such a way that the force fraction of the drawing cut is greater than the force fraction of the pressing cut. Owing to an embodiment of this type, it is achieved that the drawing cut which is more favourable for the cutting process predominates during cutting and therefore the undesired chopping movement owing to chopping the slice from the product to be cut is avoided or reduced.

In a further development of the invention it is provided that the functional correlation r=f (α) is composed of a plurality of part functions gᵢ which meet. This can be described mathematically as follows:

$$r = f ( α ) = {{\sum }_{i = 1}}^{n} {g}_{i} ( α for αϵ [ {β}_{i - 1} , {β}_{i} ] .$$

It is possible here that these part functions meet one another discontinuously at their limits Pi, k, . . . wherein the discontinuity can lead, for example, to a visible kink or shoulder on the cutting blade or else that the discontinuity leads, for example, to a point-wise alteration of the gradient angle at the periphery (which means the same as a discontinuity in a derivation dr/dα).

However, it is also favourable here if care is taken that the transition at the borders between two part functions is filled continuously so as not to produce any undesired tears or shredding in the product to be cut. The preferred embodiment depends here on the speed of rotation or the precise conditions in the transition region.

In a preferred embodiment of the invention, it is provided that the contour follows a logarithmic spiral and the functional correlation is substantially:

r=f (α)=a*e^{k*α}.

The use of a logarithmic spiral for the spiral shape of the cutting blade has the advantage that there is a constant gradient angle along the periphery. The result is a constant ratio between pressing and drawing cut, so that the cutting process can be controlled considerably better. In contrast to an arithmetic spiral, although the logarithmic spiral offers a greater gradient angle at the end of the spiral (about 270° to 345°), it is preferred here that the cutting blade immersed in the product to be cut already produces a notch effect in the product to be cut and therefore a greater cutting angle of a later angle segment, viewed in a rotation, does not lead to an undesired chopping movement. At the same time, chopping is also suppressed during immersion of the blade into the product by the low gradient angle during immersion of the blade into the product to be cut. Two mutually complementary, positive properties are therefore simultaneously achieved in this embodiment.

In a variation of the invention it is proposed that the non-linear function does not follow a cosine spiral of the shape

r=f (α)=a* cos (k * α).

In this cosine spiral the force fractions of the pressing cut are significantly greater than the force fractions of the drawing cut, which during penetration of the blade into the product to be cut and also during the corresponding increase in the force fraction of the pressing cut during encroachment of the cutting blade in the product to be cut can, in certain circumstances, produce undesired chopping formations or tears in the product to be cut. Use of a cosine spiral in portions is not to be provided in this process, either.

The invention does not relate only to the advantageous configuration of the cutting blade, but also describes a slicing machine (commercially known as a “slicer”) with a cutting blade as described at the outset which either sits on a statically mounted drive shaft or on a moving drive shaft, a rotor which, as also known, sits, for example on a planet-like drive. Seen in plan view, the shaft also forms the fulcrum of the blade. The shoulder on the spiral blade periphery can also be used here for the forward feed of the product in the time period in which the shoulder releases the product. As an alternative thereto, the rotational movement of the rotor is used for this. It has also been proved that a cutting machine according to the invention which is equipped with the cutting blade described, achieves very good cutting results in high power cutting machines (from 1,500 rotations=1,500 cuts per minute) . The product to be cut up (for example sausage or a slab of cheese) rests on an, optionally also inclined, support face.

A forward feed device is proposed which takes care of the forward feed of the product to be cut at the correct time in the direction of the cutting blade.

1. Cutting blade, in particular for a cutting machine which cuts up food, said cutting blade being rotatably mounted about a fulcrum and said cutting edge arranged at said edge of said cutting blade being spiral in design and said cutting edge following the following functional correlation formulated in polar coordinates, at least in portions:
r=f (α) with
r: distance of said cutting edge from said fulcrum
α: angular distance with respect to a zero line (angle)
f: mathematical function,
wherein f (α) is a non-linear function.

2. Cutting blade according to claim 1, wherein said cutting blade is arranged inside an Archimedean spiral contour, wherein
r=f (α)<k * α+a (for α>0)
: gradient factor and
: radius at α=0.

3. Cutting blade according to claim 1 wherein said functional correlation r=f (α) consists in an interval of α with the lower limit of 0° to 100°, preferably 0° and an upper limit of 245° to 345°, preferably 300°.

4. Cutting blade according to claim 1 wherein said functional correlation r=f (α) is selected in such a way that the force fraction of the drawing and pressing cut of the cutting blade is in a constant ratio over the active cutting blade length and, in particular, equals 1.

5. Cutting blade according to claim 1 wherein said functional correlation r=f (α) is selected in such a way that the force fraction of the drawing cut is greater than the force fraction of the pressing cut.

6. Cutting blade according to claim 1 wherein said functional correlation is composed of a plurality of part functions gᵢ as follows
$$r = f ( α ) = {\sum }_{i = 1}^{n} {g}_{i} ( α for α ϵ [ {β}_{i - 1} , {β}_{1} ]$$
which also meet discontinuously at their limits βᵢ, k, . . .

7. Cutting blade according to claim 1 wherein said cutting contour follows a logarithmic spiral and the functional correlation is substantially
r=f (α)=a * e^{k*α}) .

8. Cutting machine according to claim 1 wherein said non-linear function does not describe a cosine spiral in the form
r=f (α)=a * cos (k*α).

9. Cutting machine, in particular high power cutting machine with an output of 600 to 2,000 cuts per minute, preferably of about 1,500 cuts per minute with a cutting blade according to claim 1, the product to be cut, for example a length of food such as a sausage, a slab of cheese or other food resting on a product support and being conveyed against the cutting blade which separates slices from the length of food.

10. Cutting machine according to claim 9, wherein said cutting machine has a shaft which forms the fulcrum of said cutting blade, and said shaft is stationary in design or movable, for example is mounted in a rotor.
